(19) United States
(12) Patent Application Publication
(10) Pub. No.: US 2005/0109752 A1
(43) Pub. Date: May 26, 2005

(54) Heating device with flexible heating body

(76) Inventors: Ernst Merk, Weissenhorn (DE); Ralf Kohler, Langenau (DE)

Correspondence Address: PAULEY PETERSEN & ERICKSON, 2800 WEST HIGGINS ROAD, SUITE 365, HOFFMAN ESTATES, IL, 60195, US

(21) Appl. No.: 10/507,804

(22) PCT Filed: Feb. 15, 2003
(86) PCT No.: PCT/EP03/01533

(30) Foreign Application Priority Data
Mar. 14, 2002 (DE) 102 11 114.6

(51) Int. Cl. H05B 1/00

(52) U.S. Cl. 219/212; 219/217; 219/507; 219/528

(57) ABSTRACT

A heating device having an electrical heating conductor arrangement integrated in a flexible heating body and connected to a supply voltage by a connector cable. A heating circuit is connected to the above and further elements, including a first control element embodied for a heating current and a drive circuit for varying the heating current and regulating the temperature, connected to the first controller and having a safety circuit. According to this invention, increased safety features are achieved, whereby the safety circuit has an error sensor device and an additional control element driven by the safety circuit and is arranged in series with the first control element in the heating circuit. The safety circuit also or only responds to an error in the control circuit and interrupts the heating current by driving the additional control element.

### BACKGROUND OF THE INVENTION

1. Field of the Invention

This invention relates to a heating device having an electrical heat-conducting arrangement, which is integrated into a flexible heating body and can be connected to a supply voltage via a connecting cable, having a heating circuit formed by the heat-conducting arrangement and further elements, including a control member for a heating current, and having a triggering circuit connected to the control member for varying the heating current and regulating the temperature.

2. Discussion of Related Art

Such a heating device has been described for example in European Patent Reference EP 0 562 850 A2, which discloses a circuit for protecting the electrical heat-conducting arrangement integrated into the flexible heating body against overheating. The triggering circuit has a temperature regulation circuit, by which a heating current is varied by a control member in the form of a thyristor for maintaining a desired temperature, for example by a phase-shift control. Other embodiments of the control member are also mentioned, for example a mechanical, thermal or other electronic switch. Control by pulse packets is also possible.

### SUMMARY OF THE INVENTION

One object of this invention is to provide a heating device of the above mentioned type, which offers dependable control and monitoring of the heating circuit.

This object is achieved with a heating device having characteristics described in this specification and in the claims. A safety circuit has an error-sensing device, and an additional control member, which can be controlled via the safety circuit, is arranged in series with the first control member, wherein the safety circuit also, or only, reacts to an error in the triggering circuit and interrupts the heating current by triggering the additional control member.

There is an improved error recognition and an improved reaction if an error is detected and is thus possible.

For error recognition and a dependable reaction in case of an error for eliminating an interference or a dangerous state are aided because the safety circuit has an evaluating element, which is in electrical connection with a control element of the triggering circuit or with the heating circuit for picking up at least one characteristic signal status or characteristic signal status changes. The safety circuit is embodied so that when picking up the at least one characteristic signal status or characteristic signal status changes, it triggers the additional control member for interrupting the heating current.

Measures are furthermore advantageous for the monitoring and evaluation functions, wherein the control element is embodied as a digital control element, and the signal status or change in the signal status relates to at least one digital signal.

Assured recognition is aided because the signal status or the change in the signal status of two separate signals, which during normal operations are complementary or identical in the normal state, are picked up by the safety circuit.

An advantageous structure results because the at least one digital signal is picked up by at least one output connection of the digital circuit element.

A simple circuit structure is obtained, for example, because a circuit element with merely one capacitor and one resistor is arranged between the output connector and the additional control member.

In one embodiment which is advantageous for the structure the safety circuit has a transistor stage as the evaluating element which, on the input side, is connected to two separate connectors of the circuit element by a base connector and an emitter connector or collector contact for picking up the at least one signal status or change in the signal status, and is connected on the output side via the collector contact or the emitter connector with a control connection of the additional control member for controlling the latter. Thus the transistor can be a bipolar transistor or also a field effect transistor, in which case the base connector, emitter connector and collector contact correspond to the gate connector, drain or source connector. A different semiconductor circuit is also possible, for example with CMOS logic or analog switches.

A further embodiment of the heating device advantageous for the function results when the signal status or the change in the signal status is picked up in the heating circuit or in a control branch leading from the circuit element to the first control member.

In one structure the safety circuit has a transistor stage as the evaluating element, which is connected by a base connector on the input side to the heating circuit or the control branch, and is connected on the output side by its emitter connector or collector contact to the control connector of the additional control member.

Furthermore, measures are advantageous for the dependable operation of the heating device, wherein the triggering circuit is connected via a coupling branch to the heating circuit for picking up an electrical measurement value which is a function of the temperature of the heat-conducting arrangement, and has a control circuit with a digitizer stage of a digital circuit arrangement for controlling the control member as a function of a deviation between an actual value and a reference variable. The triggering circuit is such that the control of the control member for regulating a set temperature of the heating body occurs on the basis of digital data formed in the digitizing stage.

For forming the actual value, the measured value is picked up by a potentiometer provided in the heating circuit, which is formed by the heat-conducting arrangement constituting a temperature-dependent resistance and by at least one resistor element. In this case, the heat-conducting arrangement, which is provided anyway, is also employed as a temperature sensor.

An advantageous structure of the triggering circuit, in particular of the control circuit, results if the measured value is provided via a supply branch to an analog time-function element with a resistor/capacitor circuit, which is connected upstream of the digitizing stage. The digitizing stage has a time-measuring member for forming a digital actual value, and the digital actual value corresponds to a digital time value up to a time when a predetermined or predeterminable charge voltage of the capacitor is reached. A reference time variable is predetermined or predeterminable as the reference variable in the digitizing stage. The triggering of the control member for heating occurs as a function of a deviation of the actual time value from the reference time variable.

In other embodiments, a safety fuse is arranged in the heating circuit on the heating body or outside of the body. The heat-conducting arrangement only has two heating conductor ends extending out of the heating body, which are directly connected at the contact points with a twin-wire connecting line via a twin-pole plug/connector unit, or a hot lead connection, as well as the contact points are located within an intermediate cord connector housing.

### BRIEF DESCRIPTION OF THE DRAWINGS

This invention is explained in greater detail in view of embodiments shown in the drawings, wherein:

FIGS. 1A and 1B are schematic representations of an electrical circuit and a modified electrical circuit of a heating device with an additional safety device;

FIG. 2 is a schematic representation of a further electrical circuit of a heating device with a modified additional safety device; and

FIG. 3 is a graph showing voltage progressions of a time member, applied over time, for deriving an actual value, a reference variable and a reference value.

### DESCRIPTION OF PREFERRED EMBODIMENTS

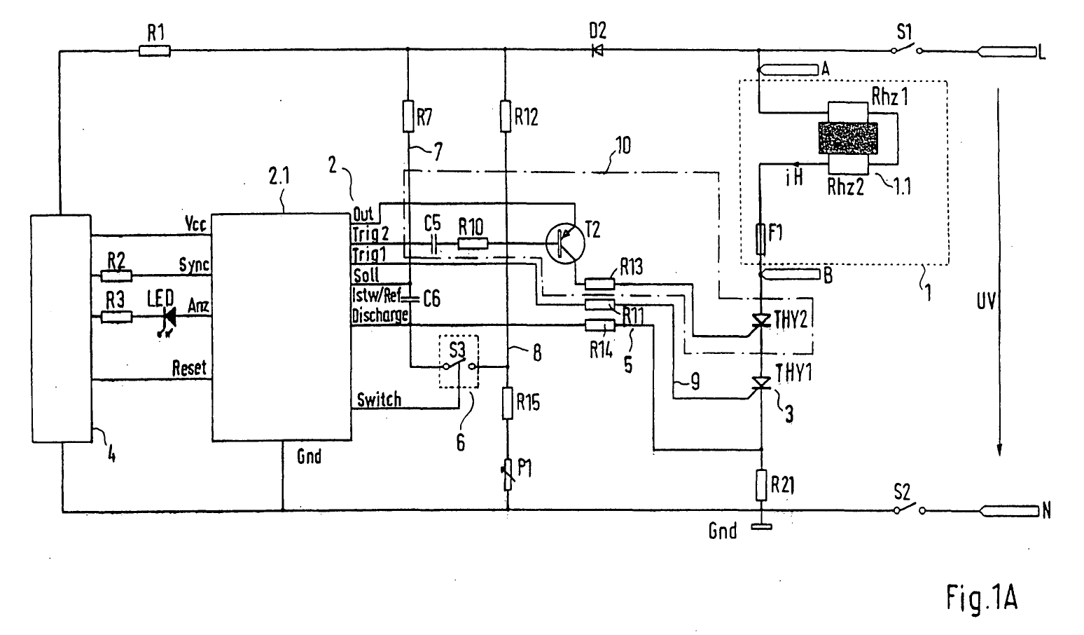

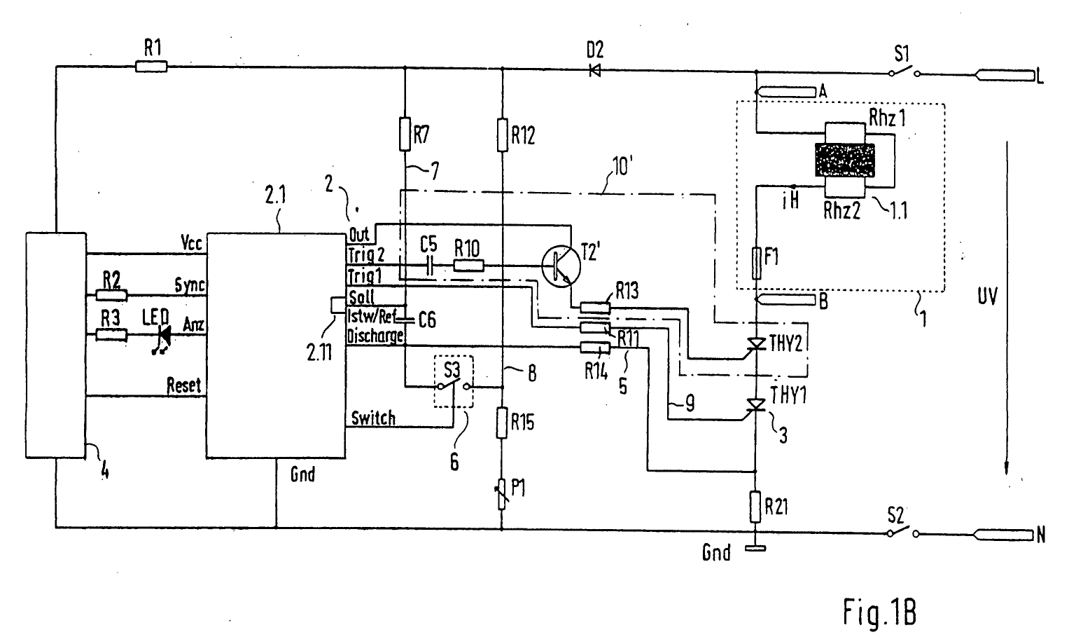

A heating device with a flexible heating body 1, for example in the form of a heating blanket, a heated pad or a heated mattress pad, is represented in FIG. 1A into which a heat-conducting arrangement 1.1 is integrated and a safety fuse F1 is housed. There is a triggering circuit 2 acting on a heating circuit 3, by which a heating current iH flowing through the heating circuit 3 with the heat-conducting arrangement 1.1 can be varied for setting a desired temperature. In this case the heating conductors can be connected with an inner conductor, arranged in one direction with respect to the current, and an outer conductor arranged in the opposite direction, for regulating the electromagnetic field, such as is known.

The heating circuit 3, which is connected to a supply voltage UV, for example a line voltage, an otherwise transformed voltage or a d.c. voltage, and which can be cut off from it by switches S1, S2, has, following the heat-conducting arrangement 1.1 and the safety fuse F1, two control members THY2 and THY1 in the form of thyristors or triacs, or other semiconductor switches, or electronically operable mechanical contacts, as well as a potentiometer resistor R21 connected to ground with its connector remote from the control member THY1 and forms, together with the heat-conducting arrangement 1.1, a potentiometer. The heating conductors Rhz1, Rhz2 of the heat-conducting arrangement 1.1 are insulated from each other, preferably by an insulator which melts at a suitable temperature, and are connected with each other as the inner conductor and the outer conductor of a heating cord, as known, by which a compensation of the electromagnetic field is also achieved. The heat-conducting arrangement 1.1 is connected at, for example two, connecting points A, B in the edge area of the flexible heating body 1, or to a short piece of cable with a plug/connector unit, and is releasable from the heating circuit 3, or is connected with the latter by fixed connector cables. The safety fuse F1 can also be arranged outside of the flexible heating body 1 in the heating circuit 3, for example in the plug/connector unit. The heating resistors Rhz1, Rhz2 have a temperature-dependent resistance, for example with a positive temperature coefficient (PTC effect) or a negative temperature coefficient (NTC effect), so that the potentiometer formed together with the potentiometer resistor R21 is temperature-dependent. Several heating circuits 3 can be provided in parallel or in series, wherein several heating cords are correspondingly arranged in the heating body 1.

The triggering circuit 2 is connected via a coupling branch 5 for picking up the component voltage developed by the potentiometer from the potentiometer resistor R21 and the heat-conducting arrangement 1.1, as well as via a triggering branch 9 to a control input of the control member THY1, and has a digital circuit arrangement 2.1, which is powered via an energy supply device 4 and is designed, for example, as a micro-computer, micro-controller, special integrated circuit arrangement (ASIC), CMOS gate or the like. A time function element is integrated into the charging branch 7 and a reference variable branch 6 and has a resistor/capacitor circuit R7, C6 and a further potentiometer 8 connected to the supply voltage UV and having fixed resistors R12, R15 and an adjustable resistor P1, wherein a further diode D2 is inserted in the conduction direction into the positive potential connection to the supply voltage UV. In this case the further diode D2 is arranged so that the entire triggering circuit 2 is connected by the latter to the supply voltage UV.

An adjustable component voltage, which can be selected in accordance with a desired temperature of the heating body 1, is picked up at the further potentiometer 8 between the two fixed resistors R12, R15 for forming the reference variable branch 6 and can be set by the adjustable resistor in the form of the potentiometer P1. Here, the potentiometer P1 is located between the fixed resistor R15 on the ground side and the ground Gnd. The component voltage picked up at the further potentiometer 8 is applied to the capacitor C6 via a controllable switch S3, which is connected for opening and closing to a connector Switch via the digital circuit arrangement 2.1. Thus, the capacitor C6 is connected with its one connector to the positive pole of the supply voltage UV via the charging resistor R7 for charging, and with its other connector to ground via the controllable switch S3 and the fixed resistor R15 and the potentiometer P1 for forming the reference variable branch 6 wherein, for developing a reference variable, the reference variable branch 6 can be temporarily closed by means of the controllable switch S3 in accordance with a triggering algorithm fixed in the digital circuit arrangement 2.1. The connector of the capacitor C6 connected with the charging resistor R7 is connected with an input connector of the digital circuit arrangement 2.1 for detecting the charge voltage and conducting it to a digitizing stage 2.11, while the other connector of the capacitor C6 is preferably connected to a discharge connection (Discharge) of the digital circuit arrangement 2.1 in order to perform a controlled complete discharge of the capacitor C6. This other connector of the capacitor C2 is connected via the coupling branch 5 with a resistor R14 for picking up the component voltage at the resistor R21 of the heating circuit 3, such as an actual measured quantity as a function of the temperature of the heat-conducting arrangement 1.1, and thus of the heating body 1, wherein the connecting point lies in the heating circuit 3 between the control member THY1 and the potentiometer resistor R21. The triggering branch 9 contains a resistor R11 and is connected to a control connector Trig 1 of the digital control circuit 2.1 in order to perform a temperature regulation of the heating body 1 as a function of a reference variable/actual value comparison, wherein suitable regulating algorithms can be preset or programmed by the digital circuit arrangement 2.1.

Alternatively, the discharge connection Discharge can also be omitted. Instead of generating component voltages via the resistors R7 and R12, it is possible to apply corresponding d.c. voltages, which are separated from the load circuit (heater), so that the resistors R7 and R12 can be dispensed. Furthermore, various reference variables can also be preset in the digital circuit arrangement and picked up via assigned connections, which can be suitably contacted by a change-over switch. The resistors R12, R15, P1 and the switch S3 can thus be replaced. In that case, pre-setting of the reference variable does not take place via the changed resistor P1, but by the change-over switch. For example, it is possible to provide a temperature-stabilized time cycle or a reference time in the digital circuit arrangement 2.1 for this purpose.

On the other side, the digital circuit arrangement 2.1 is connected via a connector Vcc to the energy supply device 4, and by a ground connector Gnd to ground potential. Also, further connections of the digital circuit arrangement 2.1 with the energy supply device 4 exist via a synchronizing connection Sync, a display connection Anz, as well as a reset connection Reset, wherein a resistor R2 is connected to the synchronizing connection Sync, and a display, such as in the form of a light-emitting diode LED, as well as a resistor arrangement R3, are connected to the display connection Anz. The energy supply device 4 is connected on one side to ground, and on the other side to the supply voltage UV via a resistor R1 and the further diode D2.

An additional control member THY2 can be placed in series with the control member THY1 upstream of the latter in the heating circuit 3, and the triggering circuit 2 has a safety circuit 10 connected to the control member THY2. The control member THY2 can be embodied here corresponding to the control member THY1 as a thyristor or similar electronic or electronically controllable switch, or it can form a separate or an integrated part of the control member THY1.

The safety circuit 10 has a transistor stage with a PNP transistor T2, which is connected with its base to a first safety connector Trig 2 via an RC member, wherein a base series resistor R10 is connected to the base, and a second capacitor C5 to the safety connector Trig 2, and which is connected with its emitter to a second safety connector OUT, which is complementary to the first, of the digital circuit arrangement 2.1. With its collector, the transistor T2 is connected via a control resistor R13 to a control connection of the additional control member THY2.

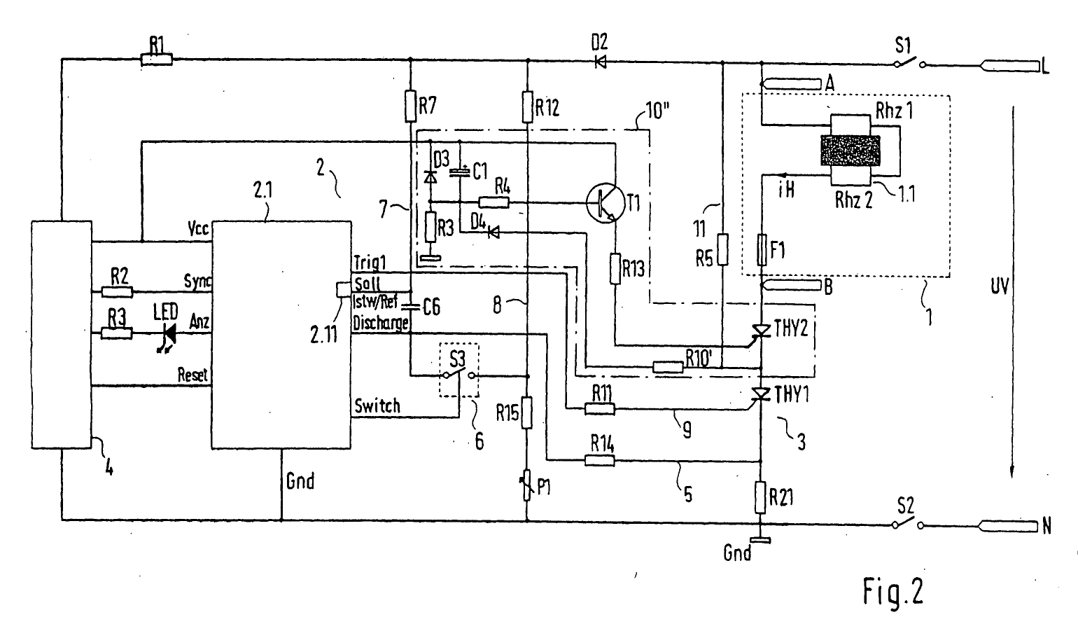

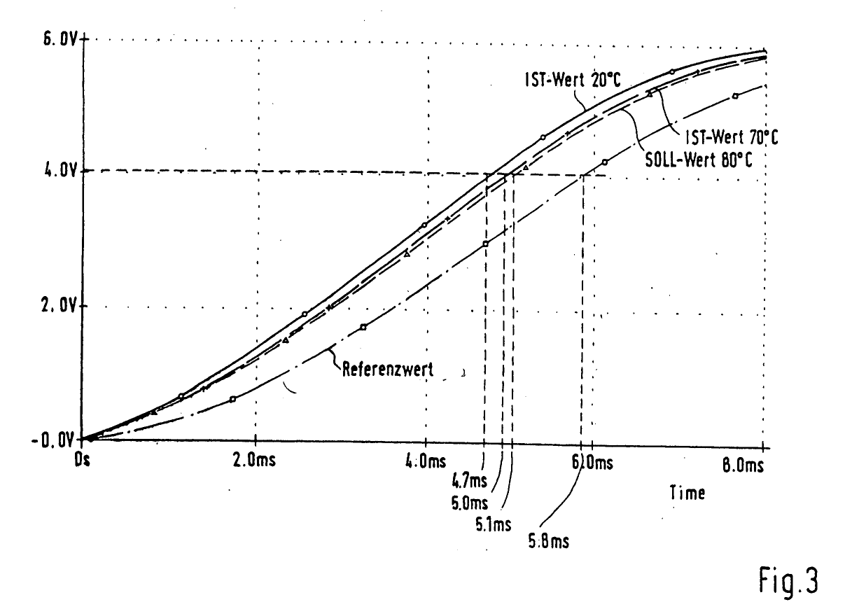

The procedure in connection with the temperature regulation is described in greater detail in view of the heating device represented in FIG. 1 and of charge curves of the capacitor C6 represented in FIG. 2, from which a reference value, the actual value at various temperatures of the heat-conducting arrangement 1.1 and the reference variable are derived. The reference value, the reference variable and the actual value are respectively determined from the charge curves of the variously wired capacitor C6, which is controlled by the digital circuit arrangement 2.1, wherein the charge times of the capacitor C6 to a defined charge voltage are determined by a digitizing stage 2.11 provided in the digital circuit arrangement 2.1. A digital time-measuring member with a fixed time cycle and a counter is provided in the digital circuit arrangement 2.1. With a comparison of the actual value in the form of an actual time value with a reference variable in the form of a reference variable time value, a decision regarding the supply of the heating current iH by means of the control member THY1, i.e. regarding heating or not heating, is made.

For determining the reference value, the capacitor C6 is completely discharged via the connectors Istw/Ref and Discharge, for example during a negative half-wave of the supply voltage UV, which is the line voltage, for example. The controllable switch S3 and the power circuit breaker in the form of the control member THY1 are not triggered, i.e. are open during the reference measurement. A zero voltage of each positive half-wave is detected by the synchronizing connection Sync and, following voltage zero, the charging process of the capacitor C6 takes place as a function of the resistors R7, R14, R21 and the further diode D2, until a digital switching level is reached at the reference input of the digital circuit arrangement 2.1. At a line frequency of 50 Hz, the charge time, which forms the reference value, is for example 5.8 ms in accordance with FIG. 2.

The controlled switch S3 is not triggered for developing the actual value, i.e. it remains open, while the control member THY1 is triggered, i.e. the heating circuit 3 is closed. Because of the current flow over the heating resistors Rhz1 and Rhz2 which are formed by the heating conductors, over the safety fuse F1, the diode D01, the control member THY1 and the potentiometer resistor R21, a voltage drop U21, which is proportional to the temperature, is created at the potentiometer resistor R21. For example, the component voltage in the form of the voltage drop U21 is approximately 1 V at a heating conductor temperature of 20° C. (peak of the positive sinus half-wave), and at the maximum temperature (80° C.) approximately 0.7 V. Because of the parallel increase of the positive charging voltage at the charging resistor R7 and the rise by the component voltage U21, the charging process of the capacitor C6 until the switching level is reached is reduced to a charging time, or an actual time value, of approximately 4.7 ms at 20° C. If, because of the heating of the heat-conducting arrangement 1.1 to 70° C. as a result of the PTC effect, the component voltage U21 is reduced to approximately 0.75 V in the maximum of the sinus half-wave, the charging process of the capacitor C6 takes place in approximately 5.0 ms.

For developing the reference variable in the form of the reference variable time value, the charging voltage of the capacitor C6, with the control member not triggered, i.e. with an open heating circuit 3, and switched-on, i.e. closed, controllable switch S3, is raised by the potentiometer P1 by approximately 0.7 V (maximum of the positive sinus half-wave) at the maximum temperature setting (80° C.). This corresponds to the component voltage U21 at the maximum temperature. This results in a charging time of the capacitor C6 until the switching level is reached of 5.1 ms (reference variable time value at 80° C.). In this case the reference variable branch 6 results because of the structural components of the further diode D2, resistor R7, capacitor C6, controllable switch S3, resistor R15 and adjustable resistor P1, together with the resistor R12 of the further voltage divider 8, wherein the controllable switch S3 is triggered by the digital circuit arrangement 2.1 via the connection Switch.

During the temperature regulation, first the reference value is determined, thereafter the reference variable and the actual value are determined as reference variable time value and actual time value. With the comparison of the charging times at the capacitor C6, performed on the basis of the derived digital data of the actual time values and the reference variable time value, a decision regarding heating or not heating is then made. When reaching the maximum temperature, identical charging times result at the capacitor C6 (wherein the component voltage U21 is 0.7 V), i.e. in the present case 5.1 ms. The triggering of the control member THY1 is then interrupted, and a pause of approximately 1 s is inserted. Thereafter the reference, reference variable and actual values are respectively determined within three line half-waves. With a further comparison a decision regarding heating or not heating is again made. In case of non-heating, a pause of 1 s is again inserted. This sequence is repeated.

In particular, the comparison of the reference variable and the actual value in the digital circuit arrangement 2.1 can also be provided to other regulating algorithms in order to provide the heating current iH in the heating circuit 3 via the control member THY1 as a function of a desired chronological temperature behavior, and/or as a function of the type of the flexible heating body 1, for example a heating blanket, a heating pad or a heated mattress pad. A suitable control algorithm can be easily programmed by a micro-computer or micro-controller, wherein it is possible to satisfy safety regulations.

One possibility of temperature regulation is when a reference variable increase and a controlled reference variable value decrease to a nominal value. Because of the thermal delay of the rise of the surface temperature of the heating element to the heat-conductor temperature because of poor heat conduction of the materials of the flexible heating body 1 it is desirable, for example, to improve the temperature rise. A solution is thus offered by the determination of a reference variable temperature value as a function of time after switching on the heating device. For achieving an excess surface temperature of an already pre-warmed heating element, the reference variable for the regulation is predetermined by an optimized method. By determining the difference between the reference variable and the actual value this can lead to a calculated temporary reheating as a result thereof after the reference variable temperature value is reached. Alternatively it is also possible to fix a calculated higher reference variable for the regulation, for example from a comparison of the reference variable and the actual value of the temperature. Thus, if the reference variable/actual value difference at the switch-on time is large, a large excess reference variable increase is fixed. The excess increase is then maintained constant or is varied, for example, until the actual value agrees with the excess increased reference variable. Thereafter a temperature gradation derived from the excess reference variable increase is started. Thus there is one advantage in that the surface temperature does not break down. But if in contrast to this the reference variable/actual value difference is the same at switch-on as during the operation, no excess reference variable increase and no controlled reference variable reduction to the nominal value are performed. Appropriate parameters for gauging the reference variable/actual value difference can be stored in the digital circuit arrangement 2.1. Depending on the type of the flexible heating body 1, for example heating pads, heated mattress pads or heating blankets, it is here also possible to provide a different calculating method for the excess reference variable increase. For example, this can be realized by the evaluation of stored software or by programmed digital inputs, or also by a time-controlled connection with or switching to another reference variable stage.

The described reference measurement can be advantageously used to detect errors. Thus the measured reference value of the charging time can be compared with the reference variable and/or the actual value, and with the results of the comparison and on the basis of already known, or stored, or input values, it is possible to detect an error in the electronic device, for example a short circuit in the control member THY1, or in connection with the controllable switch S3. The errors can be exactly localized and displayed with plausibility comparisons. The display can be designed as a simple luminous indicator up to a variable display indicator, wherein triggering by the digital circuit arrangement 2.1 can be designed in different ways, for example as a blinking warning display, or also acoustically.

Switching off the heating device can occur by a single or multiple time switch, wherein switch-off times can be integrated fixedly, or separately switchable. During extended operations a temperature reduction can be provided by an appropriate programming of the digital circuit arrangement 2.1 in order to prevent burning of the skin because of continuously high surface temperatures of the heating element. Thus it is possible to provide, starting at a defined reference variable of the temperature, a time-dependent step-down of the reference variable, or even the switching off of the heater.

With the display device, defined as a display unit LED, for example, the various operating states of the heating devices, for example reduction of the reference variable, timed shut-off, or the like, can be indicated to the user in a multitude of ways, for example by color, numbers, symbols, texts or the like. Thus it is possible to realize a blinking operation, changing colors, flashing indicator or the like, as well as an indication by sound, voice or vibration. For example, a vibrating alarm can be provided in the heating element or in a switch on the cord until the lowering of the reference variable temperature, in order to prevent, for example by a repeated operation, the user from falling asleep during critical phases.

The safety circuit 10 shown in FIG. 1A detects the states at the safety connector Trig 2 and OUT, wherein the states at the digital signals present there are complementary with respect to each other and are based on dynamic control. In case of non-heating, the control signals at the connectors Trig 1 and OUT are set to logical zero, and at the connector Trig 2 to the level of logical one. For heating, the digital signals at the connectors OUT and Trig 1 are set to one, and at the connector Trig 2 to zero. The complementary and dynamic control of the outputs at the connectors OUT and Trig 2 has one advantage that, in case of the loss of the digital circuit arrangement 2.1, in particular in the form of a micro-controller in the static continuous resetting state, wherein all outputs are set at one as a rule, or if a program counter stops, the heating current iH is always interrupted, i.e. the heater is switched off. In order to permit a non-accidental synchronization of the control of the control member THY1 in case of a program break-down, triggering of the additional control member THY2 should take place only up to respectively maximally 250 μs after a voltage zero of the triggering signal.

The heating device represented in FIGS. 1B and 2 works corresponding to the heating device in accordance with FIG. 1A, except for the safety circuits 10′ or 10″, and to this extent is correspondingly constructed.

The safety circuit 10′ in accordance with FIG. 1B is similar in structure to the safety circuit 10 in accordance with FIG. 1A, but in this case it is assumed that the same signal states of the digital signals at the safety connectors OUT and Trig 2 exist, wherein triggering is also dynamic. In this case the transistor T2′ is designed as a bipolar NPN transistor T2′, wherein the collector lies at the connector OUT, while the emitter is connected to the control connection of the additional control member THY2 via the control resistor R13. The base of the transistor T2′ is connected, corresponding to the exemplary embodiment in FIG. 1A, to the other safety connector Trig 2 via an RC member.

The safety circuit 10′ in accordance with FIG. 1B takes a digital circuit arrangement 2.1 into account, in which a reset state does not extend to all logic elements. This can be the case, for example, if the control circuit 2 has separate circuit elements for triggering the control member THY1 and the additional control member THY2 in the digital circuit arrangement.

A safety circuit 10″, which is different from the safety circuits 10 and 10′, is represented in FIG. 2. Here, the safety circuit has an evaluation element with a transistor T1, for example in the form of a bipolar NPN transistor. The collector contact is connected to a supply voltage Vcc, which is picked up, for example, at the supply voltage Vcc of the energy supply 4, while the emitter connector is connected as in the exemplary embodiment in accordance with FIG. 1B via a control resistor R13 with the control connector of the additional control member THY2 located in the heating circuit 3. The base of the transistor T1 is connected via a charging branch 11 with charge resistors R5, R10′ and a diode D4 to the supply voltage UV of the heating device, wherein a connecting point between the charge resistors R5 and R10′ is connected to the heating circuit 3 between the control member THY1 and the additional control member THY2. The anode of the diode D4 is connected to the charge resistor R10′, and its cathode to a connecting point of the base branch to which the base is connected via a base resistor R4, as well as a negative pole of a further capacitor C1, the anode of a further diode D3 and a further resistor R3 connected to ground. The positive contact of the further capacitor C1 and the cathode of the further diode D3 are connected to the supply voltage Vcc.

The safety circuit 10″ in accordance with FIG. 2 is constructed as some sort of a watchdog and is based on a dynamic control of the control member THY1, the actual power circuit breaker of the heating circuit 3, with a defined scanning ratio of, for example, 95% on-time and 5% off-time at a period length of a few, for example between one and ten seconds. The safety circuit 10″ with the additional control member THY2 in the heating circuit 3 is in the on-state as a rule. If a continuous triggering of the control member THY1 in the temperature regulation circuit as a result of an error occurs, the safety circuit 10″ detects this state by its evaluation element and switches off the additional control member THY2.

In particular, the safety circuit 10″ operates under normal circumstances, with the control member THY1 for the temperature regulation is in the on-state. The additional control member THY2 is also in the on-state, because the negative pole of the further capacitor C1 is at almost the supply voltage Vcc of the digital circuit arrangement 2.1 and the transistor T1 is controlled via the resistor R4, so that the control current for the additional control member THY2 can flow. The further diodes D3 and D4 block. During the on-time of, for example 95%, an inverse charging of the further capacitor C1 takes place, for example its negative pole is charged toward ground via the resistors R3, R4, the base of the transistor T1, the control resistor R13, the control contact (gate) of the additional control member (thyristor) THY2, the control member (thyristor) THY1 and the potentiometer resistor R21.

In the process, the transistor T1 is switched through and switches on the additional control member THY2. The off-time of the control member THY1 of approximately 5% follows this, and the voltage at the negative pole of the further capacitor C1 is again charged to nearly the supply voltage Vcc (5 V) via the charge resistors R5, R10′ and the further diode D4. This means that the additional control member THY2 always remains switched on. The diode D3 prevents the voltage at the negative pole of the further capacitor C1 from becoming more positive than at the positive pole.

In the event of a malfunction, for example a short circuit or continuous triggering of the control member THY1, there is no off-time, and the additional control member THY2 is switched off. This occurs when the voltage at the negative pole of the further capacitor C1 becomes smaller because of the inverse charge voltage from the supply voltage Vcc to ground, and inversing occurs via the resistor R3, the base resistor R4, the transistor T1, the control resistor R13, the additional control member THY2, the control member THY1 and the potentiometer resistor R21. If the triggering voltage of the transistor T1 falls below the base voltage at the transistor T1 plus the gate voltage at the additional control member THY2, plus the flow voltage at the control member THY1, the transistor D1 blocks and triggering of the additional control member THY2 is interrupted. Thus the heating current is switched off and the uncontrolled overheating of the flexible heating body 1 is prevented.

1. A heating device having an electrical heat-conducting arrangement (1.1), is integrated into a flexible heating body (1) and connectible to a supply voltage (UV) via a connecting cable, having a heating circuit (3) formed by the heat-conducting arrangement and a safety fuse (F1) and a first control member (THY1) for a heating current (iH), and having a triggering circuit (2) connected to the first control member (THY1) for varying the heating current (iH) and regulating the temperature, which is coupled to the heating circuit (3) via a coupling branch (5) for picking up an electrical measured value which is a function of a temperature of the heat-conducting arrangement (1.1), and which has a safety circuit (10, 10′) and a safety circuit (10, 10′), the heating device comprising:
the safety circuit (10, 10′, 10″) having an error-sensing device and an evaluating element in electrical connection with one of a control element of the triggering circuit (2) and the heating circuit (3) for picking up at least one of a characteristic signal status and characteristic signal status changes, and
an additional control member (THY2) controllable by the safety circuit (10, 10′) and arranged in series with the first control member (THY1) in the heating circuit (3), the safety circuit (10, 10′, 10″) reactible to an error in the triggering circuit (2) and, when picking up the at least one of the characteristic signal status and the characteristic signal status changes, interrupts the heating current (iH) by triggering the additional control member (THY2).

2. The heating device in accordance with claim 1, wherein the control element is a digital control element (2.1), and the at least one of the characteristic signal status or and the characteristic signal status changes relates to at least one digital signal.

3. The heating device in accordance with claim 2, wherein the at least one of the characteristic signal status and the characteristic signal status changes of two separate signals, which during normal operations are one of complementary and identical in a normal state are picked up by the safety circuit (10, 10′).

4. The heating device in accordance with claim 3, wherein the at least one digital signal is picked up at least at one output connection (OUT, Trig 2) of the digital circuit element (2.1).

5. The heating device in accordance with claim 4, wherein a circuit element with a capacitor (C5) and a resistor (R10) is arranged between the output connector (Trig 1) and the additional control member (THY2).

6. The heating device in accordance with claim 5, wherein the safety circuit (10, 10′) one of: has a transistor stage as an evaluating element which on an input side is connected to two separate connectors (OUT, Trig 2) of the circuit element (2.1) by a base connector and one of an emitter connector and a collector contact for picking up the at least one of the characteristic signal status and the characteristic signal status changes, and is connected on an output side via the one of the collector contact and the emitter connector with a control connection of the additional control member (THY2) for control; and has a different semiconductor circuit arrangement.

7. The heating device in accordance with claim 3, wherein the signal status of the change in the signal status is picked up in one of the heating circuit (3) and in a control branch (9) leading from the circuit element (2.1) to the first control member (THY1).

8. The heating device in accordance with claim 7, wherein the safety circuit (10″) has a transistor stage as an evaluating element which is connected by a base connector on the input side to one of the heating circuit (3) and the control branch (9), and is connected on the output side by one of an emitter connector and a collector contact to a control connector of the additional control member (THY2).

9. The heating device in accordance with claim 8, wherein a control circuit has a digitizer stage (2.11) of a digital circuit arrangement (2.1) for controlling the control member (THY1) as a function of a deviation between an actual value and a reference variable, and the triggering circuit (2) is such that control of the control member (THY1) for regulating a set temperature of the heating body (1) occurs on a basis of a digital data formed in the digitizing stage (2.11).

10. The heating device in accordance with claim 9, wherein a measured value is picked up by a potentiometer in the heating circuit (3), which is formed by the heat-conducting arrangement (1.1) forming a temperature-dependent resistance and by at least one resistor element (R21), the measured value is provided via a supply branch (5) to an analog time-function element with a resistor/capacitor circuit (R7, C6) connected upstream of the digitizing stage (2.11), the digitizing stage (2.11) has a time-measuring member for forming a digital actual value, the digital actual value corresponds to a digital time value up to a time of a predeterminable charge voltage of the capacitor (C6) is reached, a reference time variable is predeterminable as a reference variable in the digitizing stage (2.11), and a triggering of the control member (THY1) for heating occurs as a function of a deviation of the actual time value from the reference time variable.

11. The heating device in accordance with claim 10, wherein a safety fuse (F1) is arranged in the heating circuit (3) one of on the heating body (1) and outside of the heating body (1).

12. The heating device in accordance with claim 11, wherein the heat-conducting arrangement (1.1) only has two heating conductor ends extending out of the heating body (1), which are directly connected at contact points (A, B) with one of a twin-wire connecting line via a twin-pole plug/connector unit and a hot lead connection.

13. The heating device in accordance with claim 12, wherein the contact points (A, B) are located within an intermediate cord connector housing.

14. The heating device in accordance with claim 1, wherein the at least one of the characteristic signal status and the characteristic signal status changes of two separate signals, which during normal operations are one of complementary and identical in a normal state are picked up by the safety circuit (10, 10′).

15. The heating device in accordance with claim 2, wherein the at least one digital signal is picked up at least at one output connection (OUT, Trig 2) of the digital circuit element (2.1).

16. The heating device in accordance with claim 15, wherein a circuit element with a capacitor (C5) and a resistor (R10) is arranged between the output connector (Trig 1) and the additional control member (THY2).

17. The heating device in accordance with claim 1, wherein the safety circuit (10, 10′) one of: has a transistor stage as an evaluating element which on an input side is connected to two separate connectors (OUT, Trig 2) of the circuit element (2.1) by a base connector and one of an emitter connector and a collector contact for picking up the at least one of the characteristic signal status and the characteristic signal status changes, and is connected on an output side via the one of the collector contact and the emitter connector with a control connection of the additional control member (THY2) for control; and has a different semiconductor circuit arrangement.

18. The heating device in accordance with claim 1, wherein the signal status of the change in the signal status is picked up in one of the heating circuit (3) and in a control branch (9) leading from the circuit element (2.1) to the first control member (THY1).

19. The heating device in accordance with claim 18, wherein the safety circuit (10″) has a transistor stage as an evaluating element which is connected by a base connector on the input side to one of the heating circuit (3) and the control branch (9), and is connected on the output side by one of an emitter connector and a collector contact to a control connector of the additional control member (THY2).

20. The heating device in accordance with claim 1, wherein a control circuit has a digitizer stage (2.11) of a digital circuit arrangement (2.1) for controlling the control member (THY1) as a function of a deviation between an actual value and a reference variable, and the triggering circuit (2) is such that control of the control member (THY1) for regulating a set temperature of the heating body (1) occurs on a basis of a digital data formed in the digitizing stage (2.11).

21. The heating device in accordance with claim 20, wherein a measured value is picked up by a potentiometer in the heating circuit (3), which is formed by the heat-conducting arrangement (1.1) forming a temperature-dependent resistance and by at least one resistor element (R21), the measured value is provided via a supply branch (5) to an analog time-function element with a resistor/capacitor circuit (R7, C6) connected upstream of the digitizing stage (2.11), the digitizing stage (2.11) has a time-measuring member for forming a digital actual value, the digital actual value corresponds to a digital time value up to a time of a predeterminable charge voltage of the capacitor (C6) is reached, a reference time variable is predeterminable as a reference variable in the digitizing stage (2.11), and a triggering of the control member (THY1) for heating occurs as a function of a deviation of the actual time value from the reference time variable.

22. The heating device in accordance with claim 1, wherein a safety fuse (F1) is arranged in the heating circuit (3) one of on the heating body (1) and outside of the heating body (1).

23. The heating device in accordance with claim 1, wherein the heat-conducting arrangement (1.1) only has two heating conductor ends extending out of the heating body (1), which are directly connected at contact points (A, B) with one of a twin-wire connecting line via a twin-pole plug/connector unit and a hot lead connection.

24. The heating device in accordance with claim 23, wherein the contact points (A, B) are located within an intermediate cord connector housing.
